(19) United States
(12) Patent Application Publication
(10) Pub. No.: US 2012/0131438 A1
(43) Pub. Date: May 24, 2012

(54) Method and System of Web Page Content Filtering

(75) Inventors: Xiaojun Li, Hangzhou (CN); Congzhi Wang, Hangzhou (CN)

(73) Assignee: ALIBABA GROUP HOLDING LIMITED, Grand Cayman (unknown)

(21) Appl. No.: 12/867,883

(22) PCT Filed: Jul. 20, 2010
(86) PCT No.: PCT/US10/42536

§ 371 Date: Aug. 16, 2010

(30) Foreign Application Priority Data
Aug. 13, 2009 (CN) 200910165227.0

(51) Int. Cl. G06F 17/00

(52) U.S. Cl. 715/234

(57) ABSTRACT

The present disclosure provides a method and system for web page content filtering. A method comprises: examining the web page content provided by a user; obtaining at least one high risk rule from a high risk characteristic library when the examining of the web page content detects a high risk characteristic word, the at least one high risk rule corresponding to the high risk characteristic word; obtaining a characteristic score of the web page content based on matching of the at least one high risk rule to the web page content; and filtering the web page content based on the characteristic score. The difference between the present disclosure and prior art techniques is that the disclosed embodiments can more precisely carry out web page content filtering to achieve better real-time safety and reliability of an e-commerce transaction.

### CROSS REFERENCE TO RELATED PATENT APPLICATIONS

This application is a national stage application of an international patent application PCT/US10/42536, filed Jul. 20, 2010, which claims priority from Chinese Patent Application No. 200910165227.0, filed Aug. 13, 2009, entitled “Method and System of Web Page Content Filtering,” which applications are hereby incorporated in their entirety by reference.

### TECHNICAL FIELD OF THE PRESENT DISCLOSURE

The present disclosure relates to the field of internet techniques, particularly the method and system for filtering the web page content of an E-commerce website.

### TECHNICAL BACKGROUND OF THE PRESENT DISCLOSURE

Electronic commerce, also known as “e-commerce”, generally refers to type of business operation in which buyers and sellers carry out commercial and trade activities under an open internet environment through the application of computer browser/server techniques without the need to meet in person. Examples include online shopping, online trading, internet payments and other commercial activities, trade activities, and financial activities. An electronic commerce website generally contains a large group of customers and a trade market, both characterized by a huge amount of information.

Following the popularization of online trading, safety and authenticity of information has been strongly demanded of websites. Meanwhile the reliability of transactional information was also of serious concern by internet users. Hence, the necessity to perform an instantaneous verification of safety, reliability and authenticity on huge amounts of transactional information in electronic commerce activities arose.

Currently, some characteristic screening techniques are employed to ensure the safety and authenticity of information, such as, in present e-mail systems, the probability theory for filtering of information. The principle of an existing filtering method includes setting up a definite sample space at first and using the sample space to carry out information filtering. The sample space comprises predetermined characteristic information, i.e., words with potential danger. Spam characteristics information filtering and calculations are made by employing a specific calculation formula, such as the Bayes method, for a general e-mail system.

In the practical application in an e-mail system and an anti-spam system, the Bayes score of the information is calculated based on the characteristic sample library, and then based on the calculated score it is determined whether the information is spam. This method, however, considers only the probability the characteristic information in the sample library appears in the information being tested. In the web page of an e-commerce website however, the information usually contains commodity parameter characteristics. For example, when an mp3 file is published, parameter characteristics may include memory capacity and screen color, etc. There are also the parameters of business characteristics in market transactions such as unit price, initial order quantity or total quantity of supply, etc. Owing to this, it can be seen that the characteristic probability cannot be determined solely based on the single probability score. Unsafe webpage content may be published due to the omission as a result of the probability calculation, and therefore a large amount of untrue or unsafe commodity information may be generated from an e-commerce website that interferes the whole online trading market.

In brief, the most urgent technical problem to be solved in this field is how to create a method for filtering the content in an e-commerce website so as to eliminate the problem of inadequate information filtering by employing only the probability of appearance of characteristic information.

### DESCRIPTION OF THE PRESENT DISCLOSURE

An objective of the present disclosure is to provide a method for filtering web page content so as to solve the problem of poor efficiency in the filtering of web page content when searching through a large amount of information.

The present disclosure also provides a system for filtering e-commerce information to implement the method in practical applications.

The method for filtering web page content comprises:
Examination of web page content uploaded from a user terminal.
When there is a predetermined high risk characteristic word detected in the web page content during the examination, at least one high risk rule corresponding to the high risk word may be obtained by matching from a high risk characteristics library.
Based on a result of matching between the at least one high risk rule to the web page content, a characteristic score of the web page content may be obtained.
Filtering of the web page content according to the characteristic score. A web page content filtering system provided by the present disclosure comprises:
An examining unit that examines web page content uploaded from a user terminal;
A matching and rule obtaining unit that obtains from a predetermined high risk characteristic library at least one high risk rule corresponding to a predetermined high risk characteristic word detected in the web page content by the examining unit;
A characteristic score obtaining unit that obtains a characteristic score of the web page content based on a result of a match between the at least one high risk rule and the web page content;
A filtering unit that filters the web page content according to the characteristic score.

The present disclosure has the several advantages compared to prior art techniques as described below.

In one embodiment of the present disclosure when predetermined one or more predetermined high risk characteristic words are detected from existing web page content, the characteristic score would be calculated based on the high risk rule corresponding to the high risk characteristic words, and filtering of the web page content would be carried out according to the value of the characteristic score. Accordingly, more precise web page content filtering can be achieved by employing the embodiment of the present disclosure as compared with the prior art techniques which make filtering determination only based on the probability of the contents of a sample space appearing in the web page content that is being tested. Therefore, safe and reliable real-time online transactions can be guaranteed, and high efficiency in processing can be obtained. Of course, it is not necessary that an embodiment of the present disclosure should possess all the aforesaid advantages.

### DESCRIPTION OF THE DRAWINGS

The following is a brief introduction of the drawings for describing the disclosed embodiments and prior art techniques. However, the drawings described below are only examples of the embodiments of the present disclosure. Modifications and/or alterations of the present disclosure, without departing from the spirit of the present disclosure, are believed to be apparent to those skilled in the art.

FIG. 1 is a flow diagram of a web page content filtering method in accordance with a first embodiment of the present disclosure;

FIG. 2 is a flow diagram of a web page content filtering method in accordance with a second embodiment of the present disclosure;

FIG. 3 is a flow diagram of a web page content filtering method in accordance with a third embodiment of the present disclosure;

FIGS. 4a and 4b are examples of an interface for setting high risk rules in accordance with the third embodiment of the present disclosure;

FIGS. 5a, 5b, 5c and 5d are interface examples of the web page content in accordance with the third embodiment of the present disclosure;

FIG. 6 is a block diagram showing the structure of a web page content filtering system in accordance with the first embodiment of the present disclosure;

FIG. 7 is a block diagram showing the structure of a web page content filtering system in accordance with the second embodiment of the present disclosure;

FIG. 8 is a block diagram showing the structure of a web page content filtering system in accordance with the third embodiment of the present disclosure.

### DETAILED DESCRIPTION OF THE PREFERRED EMBODIMENTS

The following is a more detailed and complete description of the present disclosure with reference to the drawings. Of course, the embodiments described herein are only examples of the present disclosure. Any modifications and/or alterations of the disclosed embodiments, without departing from the spirit of the present disclosure, would be apparent to those skilled in the art, and shall still be covered by the appended claims of the present disclosure.

The present disclosure can be applied to many general or special purposes computing system environments or equipment such as personal computers, server computers, hand-held devices, portable devices, flat type equipment, multiprocessor-based computing systems or distributed computing environment containing any of the above-mentioned systems and/or devices.

The present disclosure can be described in the general context of the executable command of a computer such as a programming module. Generally the programming module would include the routine, program, object, components and data structure for executing specific missions or extract type data, and can be applied in distributed computing environments in which the computing mission is executed by remote processing equipment through a communication network. In the distributed computing environment, the programming module can be placed in the storage media of local and remote computers, including storage equipment.

The major idea of the present disclosure is that filtering of existing web page content does not depend only on the probability of the appearance of predetermined high risk characteristic words. The filtering process of the present disclosure also depends on the characteristic score of the web page content in concern, which is calculated by employing at least one high risk rule corresponding to the predetermined high risk characteristic words. The filtering of the web page content may be carried out according to the value of the characteristic score of the web page content. The methods described in the embodiments of the present disclosure can be applied to a website or a system for e-commerce trading. The system described by the embodiments of the present disclosure can be implemented in the form of software or hardware. When hardware is employed, the hardware would be connected to a server for e-commerce trading. However, when software is employed, the software may be integrated with a server for e-commerce trading as extra function. As compared with the existing techniques in which a filtering determination is made based solely on the probability of the appearance of the contents of a sample space in the information being tested, embodiments of the present disclosure can more precisely filter the web page content to guarantee safe and reliable real-time online transactions.

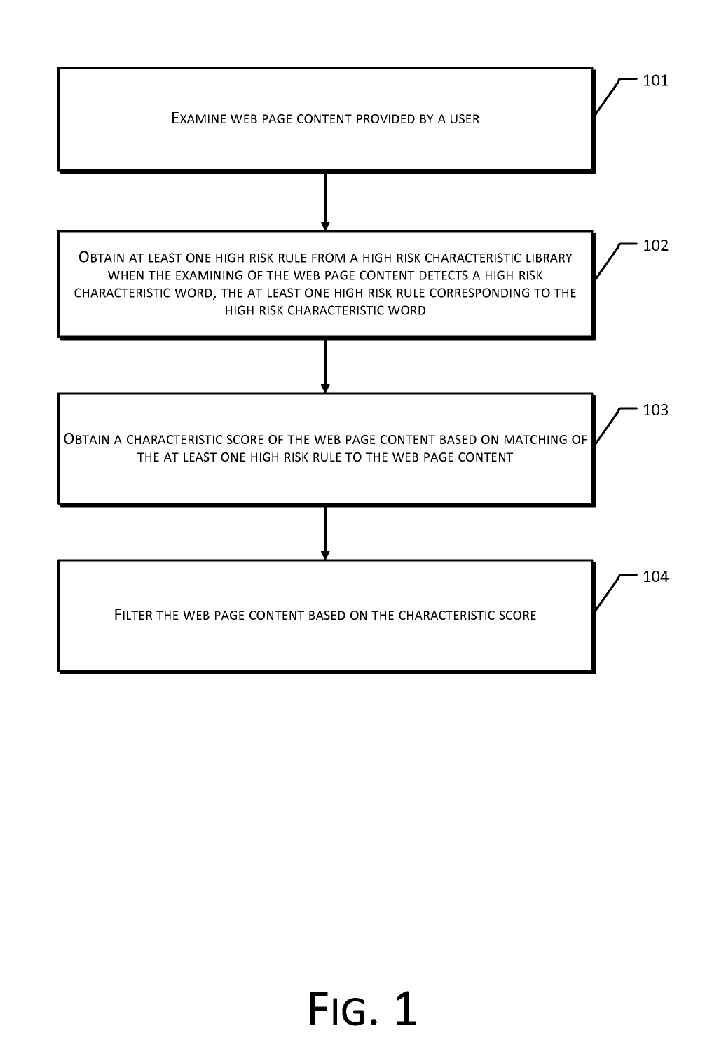

FIG. 1 illustrates a flow diagram of a web page content filtering method in accordance with a first embodiment of the present disclosure. The method includes a number of steps as described below.

Step 101: Web page content uploaded from a user terminal is examined

In this embodiment, a user sends e-commerce information to the web server of an e-commerce website through the user's terminal. The e-commerce information is entered by the user into the web page provided by the web server. The finished web page is then transformed into digital information, and sent to the web server. The web server then examines the received web page content. During the examination, the web server scans all the contents of the information being examined to determine whether the web page content contains any of the predetermined high risk characteristic words. High risk characteristic words are predetermined words or a sentence and include commonly used tabooed words, product-related words or words designated by a network administrator. In one embodiment, an ON and OFF function can be further arranged for the high risk characteristic words such that when the function is set in the ON state for a particular high risk characteristic word, this particular high risk characteristic word will be used for the filtering of the e-commerce information.

A special function of the high risk characteristic words can also be set such that the high risk characteristic words will neglect the restrictions of capitalized letters, small letters, spacing, middle characters, or arbitrary characters, such as, for example, the words of “Falun-Gong” and “Falun g”. If the special function is set, words corresponding to the special function of the high risk characteristic words will also be considered as a condition for filtering the e-commerce information.

Step 102: When a predetermined high risk characteristic word is detected from the web page content, at least one high risk rule corresponding to the detected high risk characteristic word is obtained from the predetermined high risk characteristic library.

The high risk characteristic library is designed for the storage of high risk characteristic words with at least one high risk rule corresponding to each of the high risk characteristic words. Thus, each high risk characteristic word may correspond to one or more than one high risk rules. The high risk characteristic library can be pre-arranged in such a way that each time the high risk characteristic library is used, the correlation between high risk characteristic words and respective high risk rules can be obtained directly from the high risk characteristic library. When the examination in step 101 shows the web page content contains a high risk characteristic word, at least one high risk rule corresponding to the high risk characteristic word would be obtained from the high risk characteristic library. The contents of the high risk rule would be the restrictions or additional content corresponding to the high risk characteristic word. When the web page content published from a user terminal is determined to be in conformity with the restriction or additional content set by the high risk rule, it would mean the web page content may be false or inappropriate for publication. The high risk rules may contain: type or types of information in the web page content, name or names of one or more publishers, or elements associated with the appearance of the predetermined high risk characteristic words, etc. The correlation between the at least one high risk rule and the high risk characteristic word would be considered as the necessary condition for carrying out filtering of the web page content. For example, when the high risk characteristic word is “Nike”, the high risk rule may include for example restriction on price or description of size, etc.

In the present disclosure the high risk characteristic words are not only words which are inappropriate to be published such as “Falun Gong”, but also a product name such as “Nike”. If web page content contains the high risk characteristic word “Nike”, and if a corresponding high risk rule contains the element of “price<150” (the information of Nike with price below that of the market price would be considered false information), it would be deemed the current e-commerce information is false information. The respective web page content would then be filtered out based on the calculated characteristic score, so as to prevent users from being cheated when seeing that particular web page content.

High risk characteristic words can be pre-set according to contents of the website information library. E-commerce information of the website can be kept in the website information library for a considerably long period of time. Based on the history of e-commerce trading information, the high risk characteristic word which is likely to be contained in the false information or the information not appropriate to be published can be easily picked out.

Step 103: Based on the at least one high risk rule, carry out matching in the web page content to obtain the characteristic score of the web page content.

After at least one high risk rule is obtained based on high risk characteristic words, matching in the web page content is continued wherein the matching is carried out for each high risk characteristic word in sequence with each high risk characteristic word matched with each high risk rule in sequence. Once the matching of a high risk characteristic word is completed, the matching for at least one corresponding high risk rule shall be followed (i.e., to determine whether there is any information conforming the high risk rule). When the matching of all the high risk rules is completed, the matching of the high risk rules is deemed successfully completed, and the scores corresponding to the high risk rules shall be obtained. When the scores corresponding to all the high risk rules are obtained, total probability formula is employed for calculation. In one embodiment, the numerical computation capability of Java language is employed to manipulate the total probability calculation to obtain the characteristic score of the web page content. The range of the characteristic score can be any decimal fraction number from 0 to 1.

In the present disclosure different scores may be pre-set for different high risk rules. Referring to the sample high risk characteristic word “Nike”, a pre-set score of 0.8 can be set for price<50, a pre-set score of 0.6 for price<150, and a score of 0.3 for 150<price<300. In this way a more precise score can be obtained.

Following is a brief introduction of total probability. Normally in order to obtain the probability of a complex event, the event is decomposed into several independent simple events. One then obtains the probability of these simple events by employing conditional probability and the multiplication calculation formula, and then obtains the resultant probability by employing the superposition property of probability. The generalization of this method is called the total probability calculation. The principle is described below.

Assume A and B are two events, and then A can be expressed as:

A=AB∪A B̅

Of course, AB∩AB=φ, if P(B), P( B̅)>0 then P(A)=P(AB)+P (A B̅)=P(AlB) P(B)+P(Al B̅) P ( B̅)

For example, if three high risk rules are obtained through matching, and the corresponding pre-set scores are 0.4, 0.6 and 0.9, then the calculation by the total probability formula is:

Characteristic score=(0.4×0.6×0.9)/((0.4×0.6×0.9)+((1−0.4)×(1−0.6)×(1−0.9))).

Step 104: Based on the characteristic score, filter the web page content.

The filtering can be done by comparing the value of the characteristic score with the pre-set threshold. For example, when the characteristic score is greater than 0.6, it is deemed the web page content contains hazardous information which is not appropriate to be published. Therefore the web page content would be transferred to background or shielded. When the characteristic score is smaller than 0.6, it is deemed the contents of the web page are safe or true, and the web page content can be published. This technique filters out the unsafe or false information not appropriate to be published.

The present disclosure can be applied to any web site and system used in carrying out e-commerce trading. In the embodiments of the present disclosure, since a high risk rule is obtained from the high risk characteristic library corresponding to a high risk characteristic word appearing in the web page content, and the pre-set score for the high risk rule is obtained only when the web page content contains some high risk characteristic word, then based on all the pre-set scores the characteristic score of the web page is calculated by employing the total probability formula. As compared with existing techniques which filter only by using the probability of appearance of the sample space in trading information, the embodiments of the present disclosure can more precisely carry out filtering of web page content, and ensure the real-time safety and reliability of online trading.

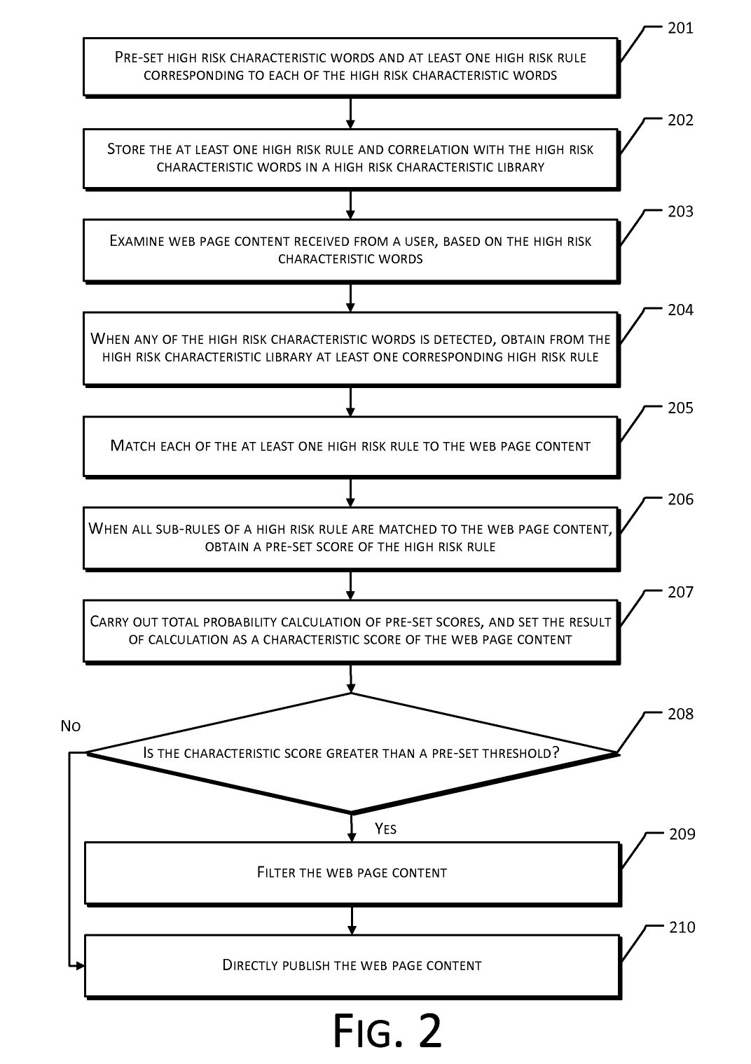

Shown in FIG. 2 is the flow diagram of a second embodiment of a web page content filtering method of the present disclosure. The method comprises a number of steps that are described below.

Step 201: Pre-set high risk characteristic words and at least one high risk rule corresponding to each of the high risk characteristic words.

In one embodiment, high risk characteristic words can be managed by a special system. Practically, web page content may contain several parts, each of which would be matched to the high risk characteristic words. The high risk characteristic words may include many different subjects such as: title of the web page, keywords, categories, detailed descriptions of the web page content, transaction parameters and professional description of web content, etc.

Each high risk characteristic word can be controlled by a switch by way of a function to turn on and off the high risk characteristic word. Practically, this can be achieved by changing a set of switching characters in a database. In one embodiment the systems for carrying out the web page content filtering and high risk characteristic words management are different. The system for managing the high risk characteristic words can regularly update the high risk characteristic library, so it will not interfere with the normal operation of the filtering system. Practically, if required to set a special purpose use of the high risk characteristic words, regular expression of Java language can be employed to achieve the purpose.

Meanwhile, as for the predetermined high risk characteristic words, the corresponding high risk rules are set at the entrance of the information maintenance system. At least one corresponding high risk rule would be set corresponding to the high risk characteristic word. The contents of the high risk rule may include: one or more types of web page content, one or more publishers of the web page content, element of appearance of the high risk characteristic word of the web page content, the attribute word of the high risk characteristic of the web page content, the business authorization mark designate by the web page content, apparent parameter characteristics of the web page content, designated score of the web page content, etc. The pre-set score to be mentioned in the following is the pre-designated score in this step. The score may be the number of 2 or 1, or any decimal fraction number between 0 and 1.

The high risk rule can also be set in the ON state. When the high risk rule is in the ON state, it shall be deemed in effect during filtering. Those high risk rules in the ON state will each be available for matching to a corresponding high risk characteristic word in when matching the high risk rule in the high risk characteristic library.

Step 202: Store at least one high risk rule and its correlation with a corresponding one or more high risk characteristic words in the high risk characteristic library.

The high risk characteristic library can be implemented by way of a permanent type data structure to facilitate the repeated use of the high risk characteristic words or high risk rules, and to facilitate the successive updating and modification of the high risk characteristic library.

Step 203: Carry out examination of the web page content provided from a user terminal based on the high risk characteristic words.

Step 204: When the examination detects that the web page content contains one or more of the predetermined high risk characteristic words, obtain from the high risk characteristic library at least one high risk rule corresponding to each of the high risk characteristic words detected from the examination.

Step 205: Use at least one high risk rule to match the web page content. When the examination detects that the web page content contains one or more predetermined high risk characteristic words, and at least one high risk rule corresponding to the one or more high risk characteristic words is obtained from the high risk characteristic library based on the correlation between each high risk rule and respective one or more high risk characteristic words, matching between the web page content and the at least one high risk rule is carried out to verify whether the content of the web page contains elements described in the at least one high risk rule.

When carrying out matching, the high risk rule can be decomposed into several sub-high risk rules. Therefore, in this step, the matching of one high risk rule can be replaced by matching all the sub-high risk rules with the web page content.

Step 206: When all the sub-high risk rules of the high risk rule are matched, the pre-set score of the high risk rule is obtained.

A high risk rule can comprise several sub-rules. When all the sub-rules of a high risk rule can be successfully matched to the web page content, the pre-set score of the high risk rule can be obtained from the high risk characteristic library. This step is to ensure that the high risk rule is an effective high risk rule, which has been successfully matched with the high risk characteristic words, and shall be used for the calculation of the total probability to be mentioned in the next step.

When presetting the score for a high risk rule, if the score can be set to a specific value, then a web page with content matching this particular high risk rule may be deemed inappropriate for publishing. For example, a pre-set score of 2 or 1 of a high risk characteristic word represents that the web page content containing the high risk characteristic word is unsafe or unreliable, and the filtering process can directly proceed to step 209. When obtaining the pre-set scores of the high risk rules, the scores can be arranged in reversed order according to the value of the scores. This will provide the convenience of finding out from the start, the web page content corresponding to the highest pre-set score.

Assume web page content is detected to have a match with a high risk characteristic word, and the high risk characteristic word is matched to five high risk rules. In the preceding step if only the contents of four high risk rules are contained in the web page content, then in step 207 the calculation of the total probability may be made only against the pre-set scores of those four high risk rules.

Step 208: Determine whether the characteristic score is greater than a pre-set threshold; if yes, proceed to step 209; if no, proceed to step 210.

When determining whether the characteristic score is greater than the pre-set threshold such as 0.6, the value of the threshold can be set according to the precision required in practical application.

Step 209: Carry out filtering of the web page content.

If the characteristic score is 0.8, it means the web page content contains one or more high risk characteristic words inappropriate to be published. After the inappropriate information is filtered out, the remaining part of the web page content may be displayed to a network administrator. The network administrator may carry out manual intervention regarding the web page content to improve the quality of the network environment.

Step 210: Publish the web page content directly.

If the characteristic score is smaller than the pre-set threshold such as 0.6, then the safety of the web page content would be deemed to meet the requirements of the network environment, and the web page content could be published directly.

In one embodiment the filtering of web page content is carried out by means of a predetermined high risk characteristic library. The high risk characteristic library comprises predetermined high risk characteristic words, high risk rules corresponding to the high risk characteristic words, and the correlation between the high risk characteristic words and the high risk rules. The high risk characteristic library is managed by a special maintenance system, which can be independent from and outside of the filtering system of the present disclosure. This type of arrangement can provide the convenience of increasing or updating the high risk characteristic words and the high risk rules as well as the correlation between them, without impacting the operation of the filtering system.

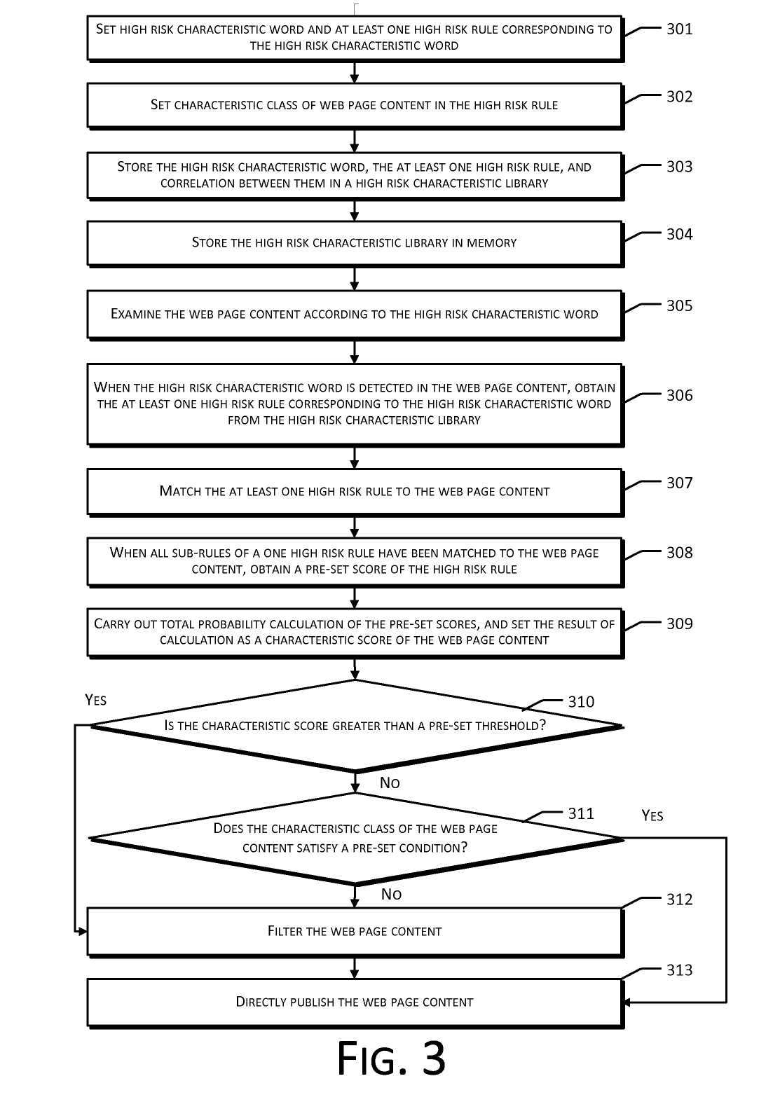

Shown in FIG. 3 is the flow diagram of a third embodiment of a web page filtering method of the present disclosure. This embodiment is another example of the practical application of the present disclosure. The method comprises a number of steps as described below.

Step 301: Identify a high risk characteristic word and at least one corresponding high risk rule.

In some embodiments, all the tabooed words, product names, or words determined to be high risk words according to the requirement of the network are set as high risk characteristic words. However, the web page content containing the high risk characteristic words may not be considered false or unsafe information because further detection and judgment, based on the corresponding high risk rules, is still required for determining the quality of the information. The correlation between a high risk rule and a high risk characteristic word can be a correlation between the high risk characteristic word and the name of the high risk rule. The name of a high risk rule can only correspond to a specific high risk rule.

As an example, if the high risk characteristic word is “Nike”, the corresponding high risk rule may be set as NIKE|Nikêshoeŝprice<150, which means the scope described by the high risk rule is “shoes”, its contents include “price<150”. If the web page content includes the contents of the rule, then obtain the pre-set score. If the web page content contains the information of Nike shoe price less than 150, the web page content will be deemed false or unreliable information.

Step 302: In the high risk rule, set the characteristic class corresponding to the web page content.

In one embodiment the definition of high risk rule can also include characteristic class, and thus the characteristic class of the web page content can also be set in the high risk rule. The characteristic class may include classes A, B, C, and D for example. It can be set in such a way that the web page content of class A and class B may be published directly, and the web page content of class C and class D are deemed unsafe or false and may be directly transferred to background, or be deleted or modified (e.g., the unsafe information may be eliminated from the web page content before publishing of the web page).

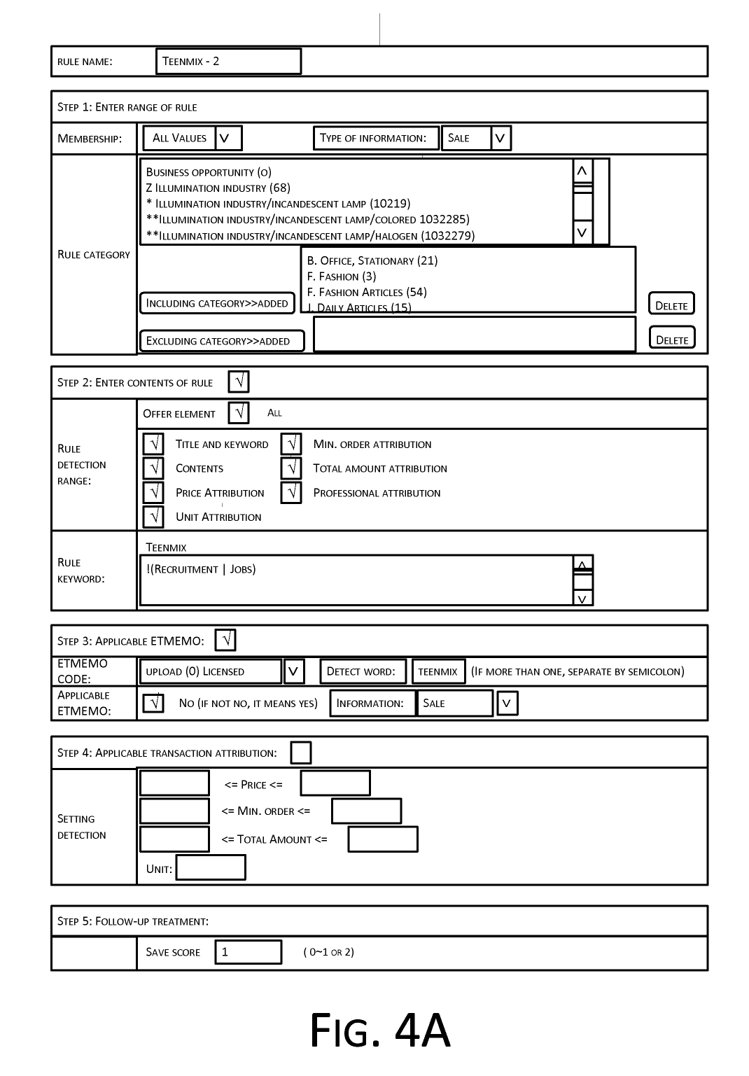

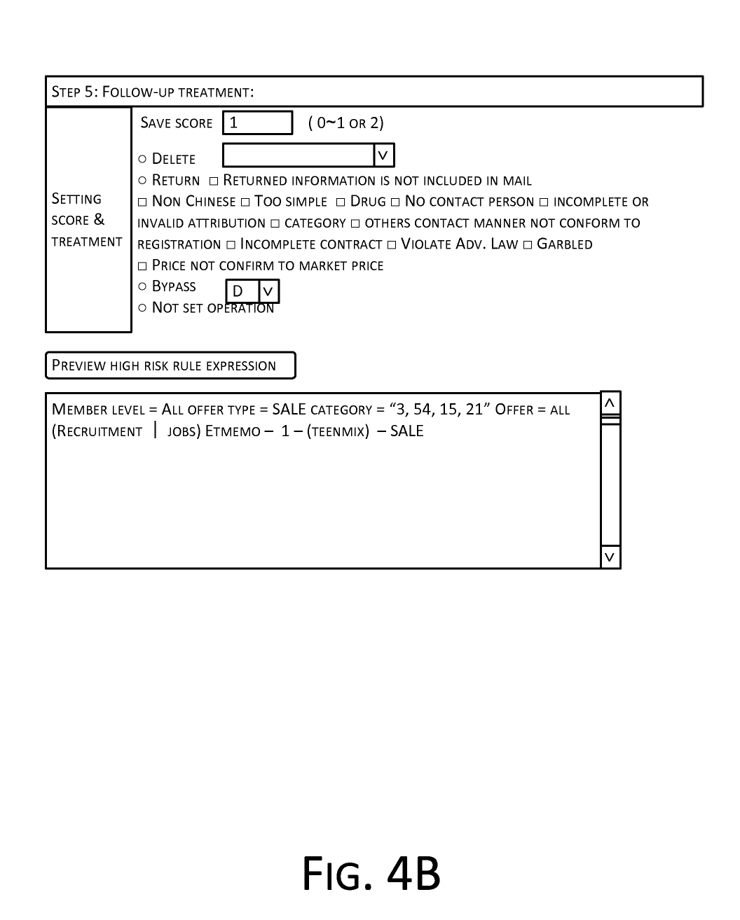

FIGS. 4a and 4b show the schematic layout of an interface for setting a high risk rule in one embodiment. Here, the rule name “Teenmix-2” is the name of a high risk rule corresponding to a high risk characteristic word. The first step of “Enter range of rule” and the fifth step of “follow-up treatment” are required elements of the high risk rule that need to be pre-set. The first step “Enter range of rule” is for defining the field or industry of the high risk characteristic word corresponding to the high risk rule, i.e., in what field or industry the high risk rule matching on the web page content shall be deemed an effective high risk rule and an effective match. For example, when the high risk characteristic word “Nike” appears in the web page content, the first step is to detect whether the web page content is related to fashion articles or sports articles because different kinds of commodities will have different price levels. Therefore, it will be a requirement to examine the web page content to make sure the information contained therein is in the range or category pre-set in the high risk rule, so a more accurate result can be obtained in follow-up price matching. The second step “enter description of rule” denotes on which part or parts of the web page content the matching of the high risk rule shall be carried out.

For example, the matching can be carried out on the title of the web page content, or on the content of the web page, or on the attribute of price information. The contents in step 3 and step 4 are the selectable setting articles. If a more detailed classification of high risk rule is needed, the contents in step 3 and step 4 can be chosen for setting. The content of step 5 “Follow-up treatment” denotes, if no high risk rule was matched in the web page content, how to carry out follow-up treatment. The number shown in the input frame “save score” of FIG. 4b is the pre-set score of the high risk rule. The range of the score is 0-1 or 2. The character in the dropdown frame of “Bypass” is the characteristic class of the high risk rule which can be arranged into different class levels such as for example class A, class B, class C and class D.

When setting a characteristic class, the class can be adjusted according to the range of rule in step 1. For example, the class can be set based on a publisher's parameter, area of published information, feature of product and e-mail address of the publisher. To illustrate the point, assume that digital products are a high risk class, the e-commerce information of a particular geographic region is also a high risk class. In step 1 the information shown in the frame of “enter range of rule” is a digital product, then in the dropdown frame of “Bypass” the characteristic class “F” shall be selected. In general, the characteristic class can be arranged into 6 classes from A to F, in which A, B and C are not classes of high risk level but D, E and F are classes of high risk level. Of course, the characteristic class can also be adjusted or modified according to real-time conditions.

Every step of the high risk rule can be deemed a sub-rule of the high risk rule, so the sub-rules corresponding to step 1 and step 5 provide the necessary description of high risk rule, and the sub-rules corresponding to step 2, step 3 and step 4 provide preference description. It is apparent that more sub-rules added into the system according to practical requirements can be easily achieved by those skilled in the art.

Step 303: Store the high risk characteristic word, the at least one corresponding high risk rule, and the correlation between the high risk characteristic word and the at least one corresponding high risk rule in the high risk characteristic library.

The high risk characteristic library can be arranged into the form of data structure to provide the convenience of the repeated use and inquiry at a later time.

Step 304: Keep the high risk characteristic library in the memory system.

In one embodiment the high risk characteristic library can be kept in memory. In practice the high risk characteristic words can be loaded into memory from the high risk characteristic library. The high risk characteristic words can be compiled into binary data and kept in memory. This will facilitate the system to filter out the high risk characteristic words from the web page content, and to load the high risk rules into memory from the high risk characteristic library.

In one embodiment the high risk characteristic words and the correlation with the high risk rules can be taken out and put in a Hash Table. This will provide convenience for finding out the corresponding high risk rule given a high risk characteristic word, but without the requirement for a highly effective filtering process.

Step 305: Examine the web page content provided by, or received from, a user terminal

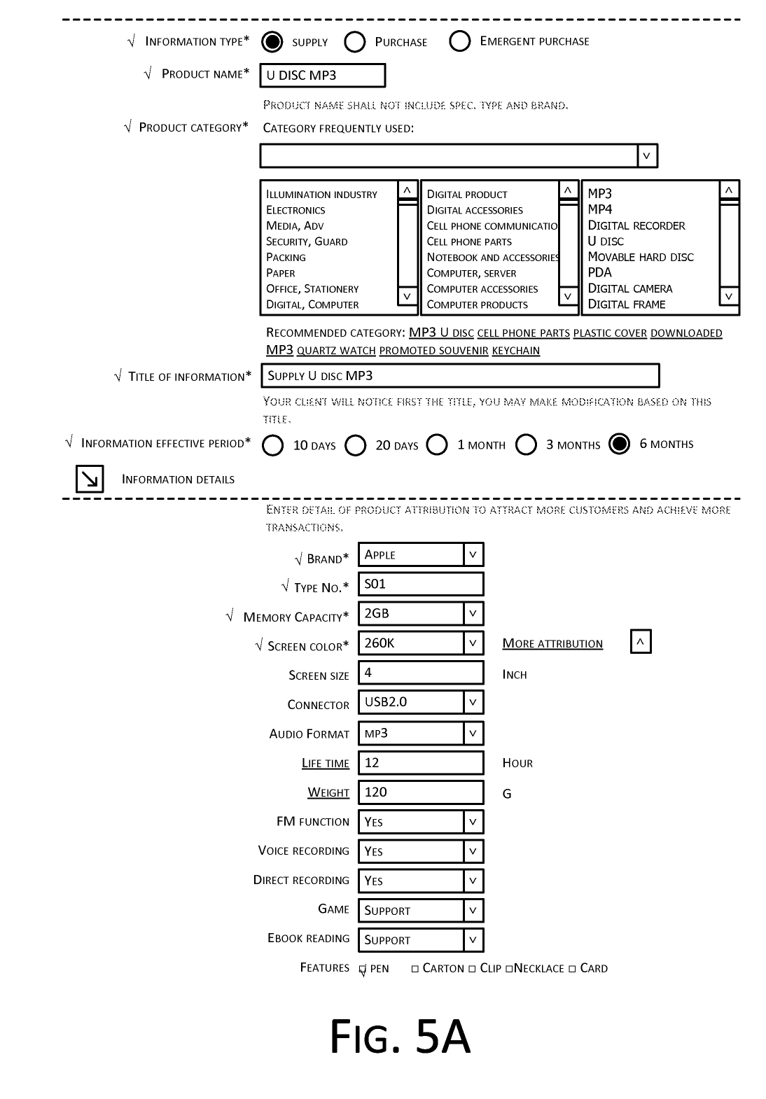

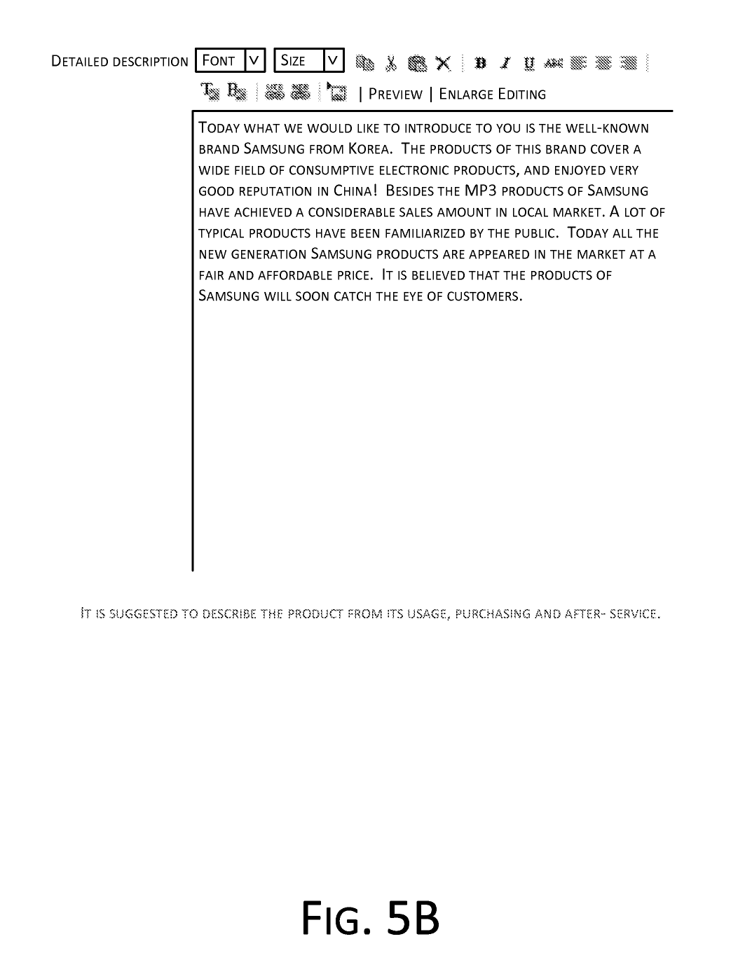

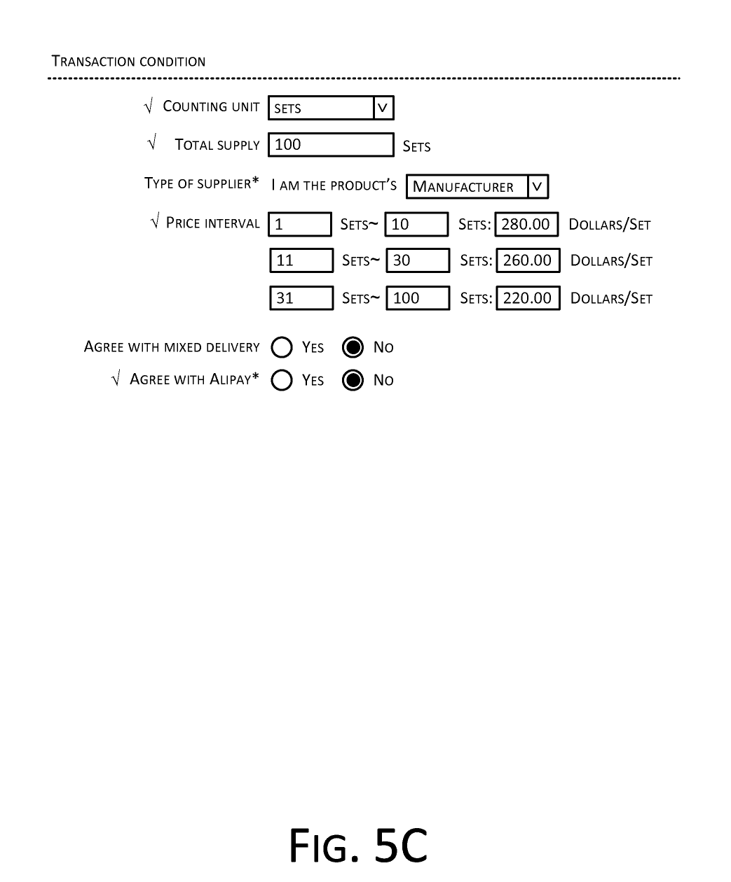

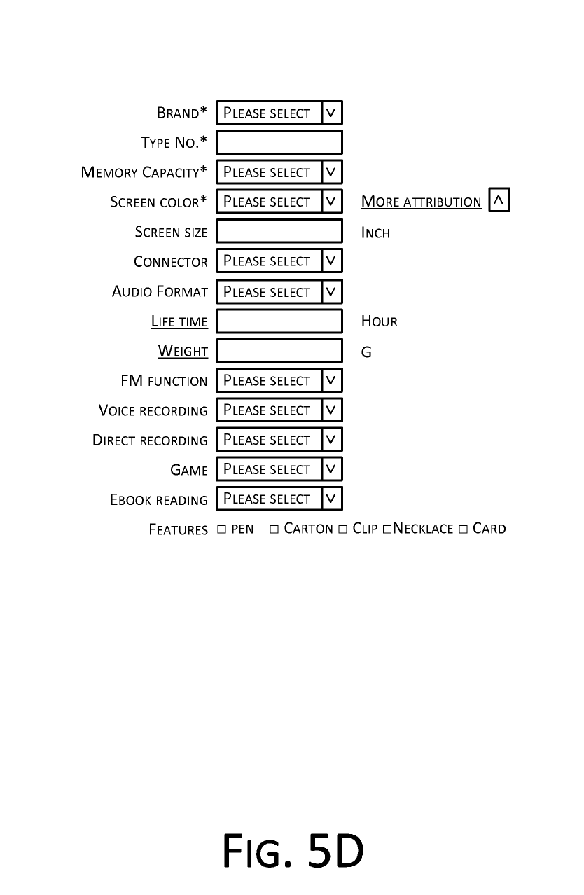

In this step the web page content in one embodiment is shown in FIGS. 5a, 5b, 5c and 5d, which depict an interface of the web page. FIG. 5c illustrates transaction parameters of the web page content and FIG. 5d illustrates profession parameters of the web page content.

The keywords of the web page content in providing MP3 products include the word MP3, with the category being digital and categorized in a cascading order as computer>digital product>MP3. The detailed description is, for example, “Today what we would like to introduce to you is the well-known brand Samsung from Korea. The products of this brand cover a wide field of consumptive electronic products, and enjoyed a very good reputation in China! Besides, the MP3 products of Samsung have achieved considerable sales in local markets. A lot of typical products are familiar to the public. Today the new generation Samsung products are appearing in the market at a fair and affordable price. It is believed that the products of Samsung will soon catch the eye of customers.”

Step 306: When the examination detects that the web page content contains one or more predetermined high risk characteristic words, at least one high risk rule corresponding to each of the one or more high risk characteristic words is obtained from the high risk characteristic library which is stored in memory.

Step 307: Carry out matching of the at least one high risk rule to the web page content.

Step 308: When all the sub-rules of the at least one high risk rule can be successfully matched to the web page content, obtain the pre-set score of the high risk rule.

For example, a regular expression corresponding to a sub-rule of a high risk rule is “Rees|Smith|just cold”, wherein “” represents “or”. The high risk characteristic words according to this sub-rule are “Rees”, “Smith” and “just cold”. Subsequently the web page content will be examined based on these high risk characteristic words. The sub-rule elements in the high risk rule are marked as “true” or “false” based on whether each of these three high risk characteristic words is detected in the web page content or not. For instance, a result of “true|false|true” is in the form of Boolean logic. The result of calculation is “true”, and therefore the matching of the sub-rules is considered successful, and the pre-set score of the corresponding high risk rule will be obtained.

Step 309: Calculate the total probability of the pre-set score, and set the result of the calculation as the characteristic score of the web page content.

Assume, for the following discussion, the result of the calculation is 0.5.

Step 310: Determine whether or not the characteristic score is greater than a pre-set threshold; if not, proceed to step 311; if yes, proceed to step 312.

A pre-set threshold of 0.6 allows a more precise result to be obtained, i.e., the most preferred threshold is 0.6.

Step 311: Determine whether or not the characteristic class of the web page content meets a pre-set condition; if yes, proceed to step 313; if not, proceed to step 312.

In the present embodiment, when the characteristic score is smaller than the pre-set threshold, it is necessary to continue determining whether the characteristic class meets the pre-set conditions. For example, the web page content of class A, B or C is considered safe or reliable, while the web page content of class D, E or F is considered unsafe or unreliable. If the web page content is class B, then step 313 will be performed; but if the web page content is class F, then step 312 will be performed.

In the present embodiment, if the characteristic score is smaller than the pre-set threshold, then determination will be made as to whether the corresponding characteristic meets the pre-set conditions. For example, a web page with content of class A, B or C is considered safe and reliable, but a web page with content of class D, E or F is considered unsafe or unreliable and not appropriate for publishing directly. When web page content is class B, step 313 will be performed; but when the web page content is class F, step 312 will be performed.

In this step if there are more the one corresponding high risk rule existing in the web page content, and more than one pre-set characteristic class obtained, the highest characteristic class shall be chosen as the characteristic class of the web page content.

Step 312: Filter the web page content.

In addition to filtering of the web page content, special treatment of the content may be made by a technician so as to ensure the safety and reliability of the web page content before it is published.

Step 313: Publish the web page content.

The actions utilizing characteristic class in 310-313 provide adjustment to determination of web page content based on characteristic scores. Accordingly, under the circumstances that characteristic scores are used to determine whether or not information contained in web page content is false, the information is deemed false and inappropriate for publishing when the characteristic class of the web page content is certain characteristic class, or when the characteristic class of the web page content is certain characteristic class plus the characteristic score is close to the pre-set threshold. On the other hand, in the filtering process, when characteristic scores are used to determine whether or not information contained in web page content is false, the determination may partially be based on the characteristic class. If the characteristic class is certain characteristic class, even if the characteristic score is greater than the pre-set threshold, the web page content may still be deemed safe and reliable and is appropriate for publishing directly.

In this embodiment the high risk characteristic library can be kept in memory. This can provide convenience in retrieving the high risk characteristic words and high risk rules to ensure high efficiency of the processing operation, and thereby achieving more precise filtering of web page content as compared with prior art technology.

In the interest of brevity, the above-mentioned embodiments are expressed as the combination of a series of action. However, it will be apparent to those skilled in the art that the present disclosure shall not be restricted to the order of the actions as described above because same steps in the present disclosure can be carried out in different orders, or can be carried out in parallel. Further, it will be understood by those skilled in the art that the embodiments described herein are the preferred embodiments in which the actions and modules may not be the necessary actions and modules needed by the present disclosure.

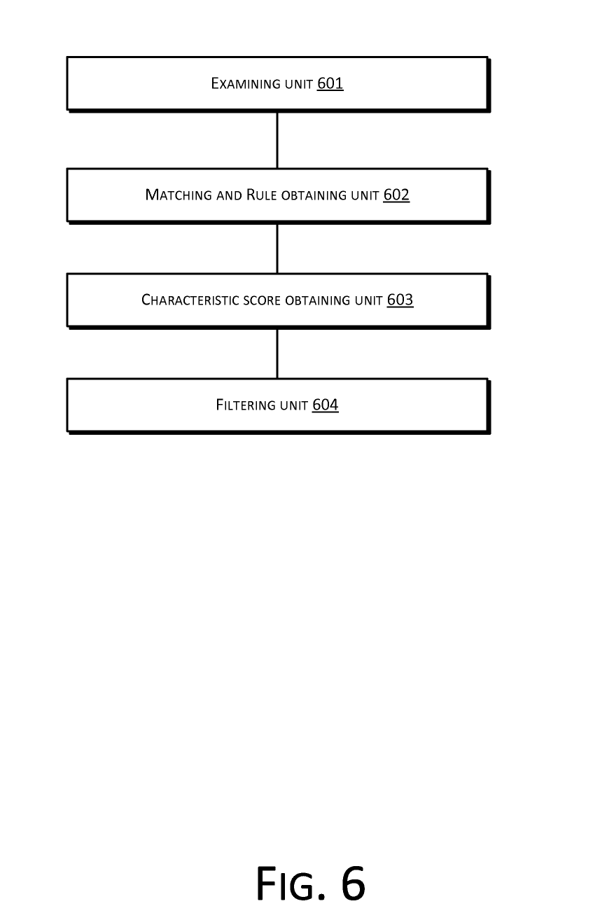

Corresponding to the method provided in the first embodiment of the web page content filtering method of the present disclosure, a first embodiment of web page content filtering system is also provided as shown in FIG. 6. The filtering system comprises a number of components described below.

Examining Unit 601 examines the web page content provided by, or received from, a user terminal

In this embodiment, through a user's terminal a user provides e-commerce related information to the website of an e-commerce server. The user enters the e-commerce related information into the web page provided by the web server. The completed web page content is then transformed into digital information, and delivered to the web server, the web server will then carry out examination of the received web page content. Examining unit 601 is required to carry out a scan over the complete content of the received information to determine whether the content of the web page contains any of the predetermined high risk characteristic words. The high risk characteristic words are the predetermined words or word combinations including general taboo words, product related words, or words designated by a network administrator.

Matching and Rule Obtaining Unit 602 obtains at least one high risk rule corresponding to each of the high risk characteristic words from the predetermined high risk characteristic library.

The high risk characteristic library is for keeping the high risk characteristic words, at least one risk rule corresponding to each of the high risk characteristic words, and the correlation between high risk characteristic words and the high risk rules. The high risk characteristic library can be predetermined so that the corresponding information can be obtained directly from the high risk characteristic library. The contents of the high risk rules would include the restrictions or additional contents relating to the high risk characteristic words such as: one or more types of web page, one or more publishers, or one or more elements related to the appearance of high risk characteristic words. The high risk rules and the high risk characteristic words correspond to each other. Their combination is considered the necessary condition for carrying out web page content filtering.

Characteristic Score Obtaining Unit 603 obtains the characteristic score of the web page content based on matching the at least one high risk rule to the web page content.

The web page content is matched to the high risk rules that correspond to the high risk characteristic words detected in the web page content. The matching may be carried out in the order of appearance of the high risk characteristic words in the web page content, and the matching of the high risk characteristic words may be made one by one, according to the order of high risk rules. When the matching of a high risk characteristic word is completed, the matching of the corresponding at least one high risk rule will be made. When all the high risk rules have been matched to the web page content, the matching of the high risk rules is deemed completed and the corresponding pre-set score may be obtained. When the pre-set scores based on all the high risk rules are obtained, the final score is calculated by employing the total probability formula. The result of the calculation may be used as the characteristic score of the web page content, with the range of the characteristic score being any number between 0 and 1.

Filtering Unit 604 filters the web page content based on the characteristic score.

The filtering may be done by comparing the characteristic score with the pre-set threshold to see whether the characteristic score is greater than the threshold. For example, when the characteristic score is greater than 0.6, the web content is deemed to contain unsafe information which is not appropriate for publishing and the information may be transferred to background for manual intervention by a network administrator. If the characteristic score is smaller than 0.6, the content of the web page is deemed safe or true, and can be published. In this way the unsafe or false information not appropriate for publishing can be filtered out.

The system of the present disclosure may be implemented in a website of e-commerce trading, and may be integrated to the server of an e-commerce system to effect the filtering of information related to e-commerce. In one embodiment the pre-set scores of the high risk rules are obtained only after the high risk characteristic words in the web page content and the high risk rules are matched from the high risk characteristic library. The characteristic score of the web page content is obtained by performing total probability calculation on all the pre-set scores. Hence web page content filtering can be more accurate to achieve safer and more reliable online transactions as compared with the existing techniques which carry out filtering only by calculating the probability of appearance of sample space in web page content.

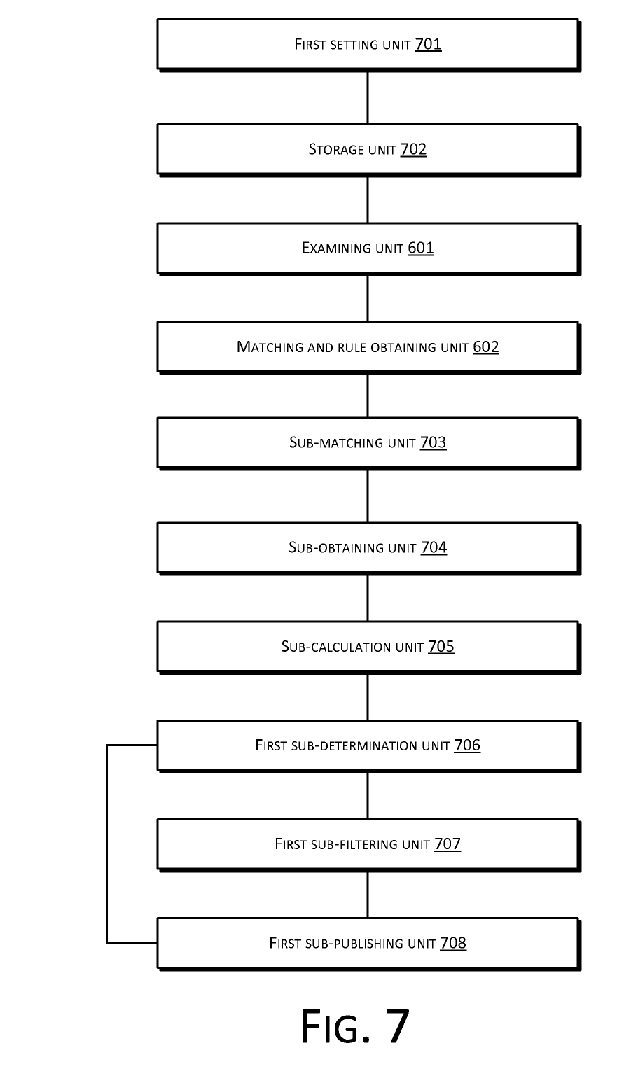

A system corresponding to the second embodiment of the method for web page content filtering is shown in FIG. 7.

The system comprises a number of components that are described below.

First Setting Unit 701 sets a high risk characteristic word and at least one corresponding high risk rule.

In this embodiment high risk characteristic words can be managed by a special maintenance system. In practice, e-commerce information usually includes many parts which may be matched to the high risk characteristic words. The high risk characteristic words may be related to various aspects such as, for example, title of the e-commerce information, keywords, categories, detailed description of the content, transaction parameters, and professional description parameters, etc.;

Storage Unit 702 stores the high risk characteristic word, the at least one corresponding high risk rule, and the correlation between the high risk characteristic words and the at least one corresponding high risk rule in the high risk characteristic library.

Examining Unit 601 examines the web page content uploaded from a user terminal

Matching and Rule Obtaining Unit 602 obtains from the high risk characteristic library at least one high risk rule corresponding to a high risk characteristic word detected in the web page content.

Sub-Matching Unit 703 matches the high risk rule to the web page content.

Sub-Obtaining Unit 704 obtains the pre-set score of the high risk rule when all the sub-rules of the high risk rule have been successfully matched.

The high risk rule may comprise several sub-rules. When all the sub-rules of a high risk rule are matched successfully to the web page content, the pre-set score of the high risk rule can be obtained from the high risk characteristic library. Accordingly, the high risk characteristic words are matched and the effective high risk rule is determined for carrying out the total probability calculation.

Sub-Calculating Unit 705 carries out the total probability calculation of all the qualified pre-set scores, and the result of the calculation is used as the characteristic score of the web page content.

Assume that a high risk characteristic word is matched to the web page content, and the high risk characteristic word has five corresponding high risk rules. For example, if the contents of only four of the aforesaid high risk rules are included in the web page content, the total probability calculation based on the four high risk rules would be used as the characteristic score of the e-commerce information.

First Sub-Determination Unit 706 determines whether or not the characteristic score is greater than the pre-set threshold.

Sub-Filtering Unit 707 filters the web page content if the result of determination by the first sub-determination unit is positive.

First Publishing Unit 708 publishes the web page content directly if the result of determination by the first sub-determination unit is negative.

In one embodiment the high risk characteristic library comprises the predetermined high risk characteristic words, the high risk rules corresponding to the high risk characteristic words, and the correlation between them. The high risk characteristic library may be managed by a special system which can be arranged into an independent system outside the filtering system, so that updating or additions of high risk characteristic words, the high risk rules, and the correlation between them can be easily made and the updating or additions will not interfere with the operation of the filtering system.

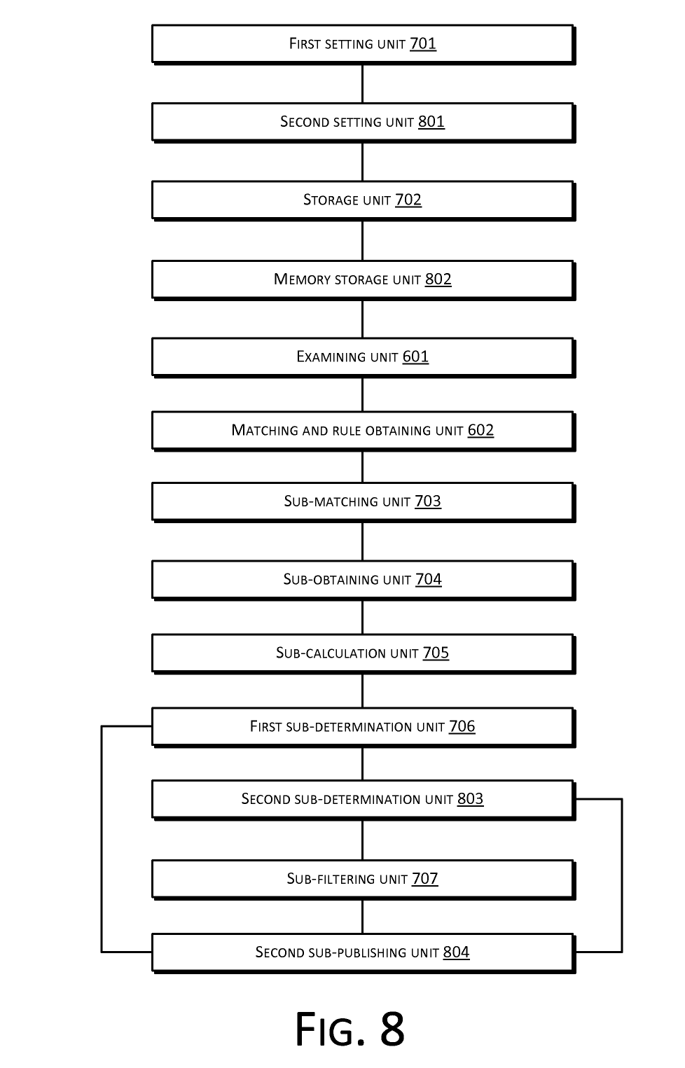

A web page content filtering system corresponding to the third embodiment is shown in FIG. 8. The system comprises a number of components described below.

First Setting Unit 701 sets the high risk characteristic words and at last one high risk rule corresponding to each of the high risk characteristic words.

Second Setting Unit 801 sets the characteristic class of the web page content in the high risk rule.

In one embodiment, a characteristic class may be set in the definition of the high risk rule such that the high risk rule may include the characteristic class of web page content. The characteristic class can be one of the classes of A, B, C and D for example, and information of class A or class B can be published directly, while the web page content of class C or class D may be unsafe or false, and manual intervention, including deletion of the unsafe information may be completed in order to publish the information.

Storage Unit 702 stores the high risk characteristic words, the at least one high risk rule corresponding to each of the high risk characteristic words, and the correlation between them in the high risk characteristic library.

Memory Storage Unit 802 stores the high risk characteristic library directly in memory.

In this embodiment, the high risk characteristic library can be stored in memory directly in such a way that the high risk characteristic words in the library are compiled into binary data, and then stored in memory. This will filter out high risk characteristic words from the web page content, and load the high risk characteristic library into memory.

In practice, the high risk characteristic words, high risk rules, and the correlation between them can be put in a Hash Table. This will facilitate identifying the corresponding high risk rule corresponding to a high risk characteristic word without the need to further enhance the performance of filtering system.

Examining Unit 601 examines the web page content uploaded from a user terminal

Matching and Rule Obtaining Unit 602 obtains at least one high risk rule corresponding to each high risk characteristic word from the high risk characteristic library when the examination detects that the web page content contains high risk characteristic words.

Sub-Matching Unit 703 matches high risk rules to the web page content.

Sub-Obtaining Unit 704 obtains the pre-set score of the high risk rule when all the sub-rules of the high risk rule have been successfully matched.

Sub-Calculation Unit 705 carries out the total probability calculation of all the qualified pre-set scores, and the result of the calculation is used as the characteristic score of the web page content.

Filtering Unit 604 filters the web page content based on the characteristic score and characteristic class.

In one embodiment the Filtering Unit 604 further comprises First Sub-Determination Unit 706, Second Sub-Determination Unit 803, Second Sub-Publishing Unit 804, and Sub-Filtering Sub Unit 707.

First Sub-Determination Unit 706 determines whether or not the characteristic score is greater than the pre-set threshold.

Second Sub-Determination Unit 803 determines whether or not the characteristic class of web page content satisfies the pre-set condition, when the result of determination of the First Sub-Determination Unit 706 is positive.

Second Sub-Publishing Unit 804 publishes the web page content when the result of determination by the Second Sub-Determination Unit 803 is positive.

Sub-Filtering Sub Unit 707 filters the web page content when the result of determination of the First Sub-Determination Unit 706 is positive, or when the result of determination by the Second Sub-Determination Unit 803 is positive.

All the embodiments illustrated above are described in a progressive manner. The focal point description of each embodiment is the difference from the other embodiment, and the similar or same part of each embodiment can be referred to after each. As for the embodiment of systems, since the principle is the same as the embodiment of methods, only a brief description is given.

In the description of the present disclosure, the terms such as the first and the second are only for the purpose of distinguishing an object or operation from other objects or operations, but not for implying the order or sequential relation between them. The term “including” and “comprising” or similar are for covering but are not exclusive. Therefore the process, method object or equipment shall include not only the elements expressively described but also the elements not expressively described, or shall include the inherent elements of the process, method, object or equipment. If there is no restriction, the restriction term “including a . . . ” will not exclude the possibility that the process, method, object or equipment including the elements shall also include other similar elements.

Above is the description of the method and system for filtering the e-commerce information. Examples have been employed for describing the principle and manner of embodiment of the present disclosure. The description of the embodiments is to help the understanding of the method and core idea of the present disclosure. Hence, modification of application and manner of implementation without departing from the spirit of the present disclosure will be apparent to those skilled in the art, and therefore will still be covered by the appended claim of the present disclosure.

What is claimed is:

1. A method of filtering web page content, the method comprising:
examining the web page content provided by a user;
obtaining at least one high risk rule from a high risk characteristic library when the examining of the web page content detects a high risk characteristic word, the at least one high risk rule corresponding to the high risk characteristic word;
obtaining a characteristic score of the web page content based on matching of the at least one high risk rule to the web page content; and
filtering the web page content based on the characteristic score.

2. The method as recited in claim 1, wherein obtaining a characteristic score of the web page content based on matching of the at least one high risk rule to the web page content comprises:
matching the at least one high risk rule to the web page content;
obtaining a pre-set score of the at least one high risk rule when the at least one high risk rule matches to the web page content; and
performing a total probability calculation based on the pre-set score to provide a result as a characteristic score of the web page content.

3. The method as recited in claim 1, wherein obtaining a characteristic score of the web page content based on matching of the at least one high risk rule to the web page content comprises:
matching the at least one high risk rule to the web page content;
obtaining a pre-set score of the at least one high risk rule when sub-rules of the at least one high risk rule match to the web page content; and
performing a total probability calculation based on the pre-set score to provide a result as a characteristic score of the web page content.

4. The method as recited in claim 1, wherein filtering the web page content based on the characteristic score comprises;
determining whether or not the characteristic score is greater than a pre-set threshold;
filtering the web page content when the characteristic score is greater than the pre-set threshold; and
publishing the web page content without filtering when the characteristic score is less than the pre-set threshold.

5. The method as recited in claim 1, before examining the web page content provided by a user, further comprising:
setting the high risk characteristic word and the at least one high risk rule corresponding to the high risk characteristic word; and
storing the high risk characteristic word, the at least one high risk rule, and a correlation between the high risk characteristic word and the at least one high risk rule in the high risk characteristic library.

6. The method as recited in claim 5, further comprising:
storing the high risk characteristic library in memory.

7. The method as recited in claim 5, further comprising:
setting a characteristic class of the web page content in the at least one high risk rule, wherein filtering the web page content based on the characteristic score comprises filtering the web page content based on the characteristic score and the characteristic class.

8. The method as recited in claim 7, wherein filtering the web page content based on the characteristic score and the characteristic class comprises;
determining whether or not the characteristic score is greater than a pre-set threshold;
filtering the web page content when the characteristic score is greater than the pre-set threshold;
determining whether or not the characteristic class satisfies a pre-set condition when the characteristic score is less than the pre-set threshold;
publishing the web page content when the characteristic class satisfies the pre-set condition; and
filtering the web page content when the characteristic class does not satisfy the pre-set condition.

9. The method as recited in claim 7, wherein filtering the web page content based on the characteristic score and the characteristic class comprises:
determining whether or not the characteristic score is greater than a pre-set threshold;
publishing the web page content when the characteristic class satisfies the pre-set condition; and
filtering the web page content when the characteristic class does not satisfy the pre-set condition.

10. A web page content filtering system comprising:
an examining unit that examines web page content received from a user;
a matching and rule obtaining unit that obtains at least one high risk rule corresponding from a high risk characteristic library when the examining unit detects a predetermined high risk characteristic word in the web page content, the at least one high risk rule corresponding to the high risk characteristic word;
a characteristic score obtaining unit that obtains a characteristic score of the web page content based on matching of the at least one high risk rule to the web page content; and
a filtering unit that filters the web page content based on the characteristic score.

11. The system as recited in claim 10, wherein the characteristic score obtaining unit comprises:
a sub-matching unit that matches the at least one high risk rule to the web page content;
a sub-obtaining unit that obtains a pre-set score of a high risk rule when sub-rules of the high risk rule have been matched to the web page content; and
a sub-calculation unit that calculates a total probability based on qualified pre-set scores to provide a result as a characteristic score of the web page content.

12. The system as recited in claim 10, wherein the filtering unit comprises:
a first sub-determination unit that determines whether the characteristic score is greater than a pre-set threshold;
a sub-filtering unit that filters the web page content when the characteristic score is greater than a pre-set threshold; and
a first publishing unit that publishes the web page content when the characteristic score is less than a pre-set threshold.

13. The system as recited in claim 10, further comprising:
a first setting unit that sets the high risk characteristic word and the at least one high risk rule corresponding to the high risk characteristic word; and
a storage unit that stores the high risk characteristic word, the at least one high risk rule, and a correlation between the high risk characteristic word and the at least one high risk rule in the high risk characteristic library.

14. The system as recited in claim 13, further comprising:
a memory storage unit that stores the high risk characteristic library in memory.

15. The system as recited in claim 13, further comprising:
a second setting unit that sets a characteristic class of the web page content in the at least one high risk rule, wherein the filtering unit filters the web page content based on the characteristic score and the characteristic class.

16. The system as recited in claim 15, wherein the filtering unit comprises:
a first sub-determination unit that determines whether or not the characteristic score is greater than a pre-set threshold;
a second sub-determination unit that determines whether or not the characteristic class satisfies a pre-set condition when a result of determination by the first sub-determination unit is positive;
a second publishing unit that publishes the web page content when the result of determination by the first sub-determination unit is nonnegative; and
a sub-filtering unit that filters the web page content when the result of determination by the first sub-determination unit is positive, or when the result of determination by the second sub-determination unit is positive.
